(19) United States
(12) Patent Application Publication
(10) Pub. No.: US 2008/0295010 A1
(43) Pub. Date: Nov. 27, 2008

(54) Systems and Methods for Incorporating Data Into Digital Files

(75) Inventor: Richard Bobbitt, Thornton, CO (US)

Correspondence Address: PATTON BOGGS LLP, 8484 WESTPARK DRIVE, SUITE 900, MCLEAN, VA, 22102, US

(73) Assignee: GeoSpatial Experts, LLC, Thornton, CO (US)

(21) Appl. No.: 12/125,701

(22) Filed: May 22, 2008

Related U.S. Application Data
(60) Provisional application No. 60/924,648, filed on May 24, 2007.

(51) Int. Cl. G06F 17/30; G06F 3/048

(52) U.S. Cl. 715/764; 707/102; 707/E17.004

(57) ABSTRACT

Software systems and methods may be provided for adding data, such as position information, to digital images stored on a computing device. A software system may be provided for integrating information from various sources on a computing device. In preferred embodiments, the software resides on a personal digital assistant (PDA) or other portable computing devices. The software may integrate information from a GPS device and a digital camera so that each image downloaded to the computing device is labeled with position information regarding where the image was taken. The software may automate and monitor downloading of images to the computing device. Once data is downloaded to the computing device, the software may automatically create a data record or allow a user to edit an existing data record to include the new images.

This application claims priority to U.S. Provisional Patent Application Ser. No. 60/924,648, filed May 24, 2007, the contents of which are herein incorporated by reference in their entirety.

### FIELD OF THE INVENTION

The invention relates generally to methods and systems for adding data to digital files, and, more particularly, to methods and systems for adding digital images to records in databases stored on a computing device.

### BACKGROUND OF THE INVENTION

Many types of computing devices may be used when collecting data in the field. For example, an individual may carry a personal digital assistant (“PDA”), laptop, or other portable computing device to enter, process and store information. The individual may also carry a global positioning system (“GPS”) device to obtain and track geographic position information. The GPS device may be a separate device or may be incorporated into the portable computing device, a cellular telephone, a digital imaging device, or another device. The individual may further carry a digital imaging device. The digital imaging device may be a separate digital imaging device, such as a digital camera, or a digital imaging device integrated into the portable computing device, the GPS device, a cellular telephone or another device. Digital images may be any electronic image file including, but not limited to, JPG, GIF, PNG, TIF, BMP, PDF, etc.

Currently, there are no effective methods for incorporating images from a digital imaging device with location and other information from databases stored on a portable computing device. Current systems require taking digital images with an on-board camera on a portable computing device, or with an external digital imaging device that transmits the digital image to the portable computing device via radio waves, infrared, wireless, cables, etc. An individual must then manually select each digital image and link the digital image to the corresponding data recorded by the GPS device. Generally, the manual process may be described by (1) taking an image with a digital imaging device, (2) opening a data entry form on the portable computing device, (3) browsing to a location of the digital image, usually among many other images with numbers for names, (4) selecting the correct digital image, and (5) saving the digital image with the location information as part of the record for the digital image. Generally, only one digital image may be associated with each location record.

In many circumstances, a user may take multiple digital images that may need to be associated with the same location record. For example, the user may take multiple digital images at a particular location during a photo shoot and may want each digital image associated with the same location record. Currently, there is no effective method for accomplishing this, even if a user tries to manually associate multiple digital images with a single location record in the field.

Furthermore, even if a user manually links the digital images, those digital images may not be labeled with the location or other associated data. Labeling of digital images with associated data may be required by some users as a way of documenting and archiving digital images.

Generally, needs exist for improved methods and systems for automatically incorporating additional information into digital image files.

### SUMMARY OF THE INVENTION

Embodiments of the present invention solve many of the problems and/or overcome many of the drawbacks and disadvantages of the prior art by providing methods and systems for incorporating additional information into digital image files.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a schematic of component interactions in embodiments of the present invention.

FIG. 2 is a flow diagram illustrating updating a current record.

FIG. 3 is a flow diagram illustrating creating a new record.

FIG. 4 is an exemplary display for record creation.

FIG. 5 is an exemplary display for viewing a map.

FIG. 6 is an exemplary display for viewing an image.

FIG. 7 shows an overview of the linking process.

### DETAILED DESCRIPTION OF THE PREFERRED EMBODIMENTS

Embodiments of the present invention may include methods and systems for incorporating additional information into digital image files. The present invention provides for easier integration of digital images with GPS or other types of collected data. Integration of digital images with collected data may be performed in the field. The integrating software of the present invention may be used as post-processing software. Previously, a user had to take photos and GPS readings separately in the field and then wait until the field data collection was completed before integrating the data. With the advent of digital cameras and other imaging devices with GPS units attached and GPS units with portable computing devices incorporated into them, a user may want to be able to link photos to coordinates and other data while still in the field. The present invention allows the user to do so automatically. Automatic incorporation may become more critical as users begin expecting real time linking of digital images to other data.

Software, methods and systems are provided that run on portable computing devices. Portable computing devices may be any portable computing devices, such as, but not limited to, laptop computers, portable digital assistants, cellular telephones, digital video devices, GPS devices, etc. For illustrative purposes, use of the software, methods and systems of the present invention may be described in relation to a PDA in the below description. One of ordinary skill in the art would recognize that the same software, methods and systems may be extended to use on other portable computing devices.

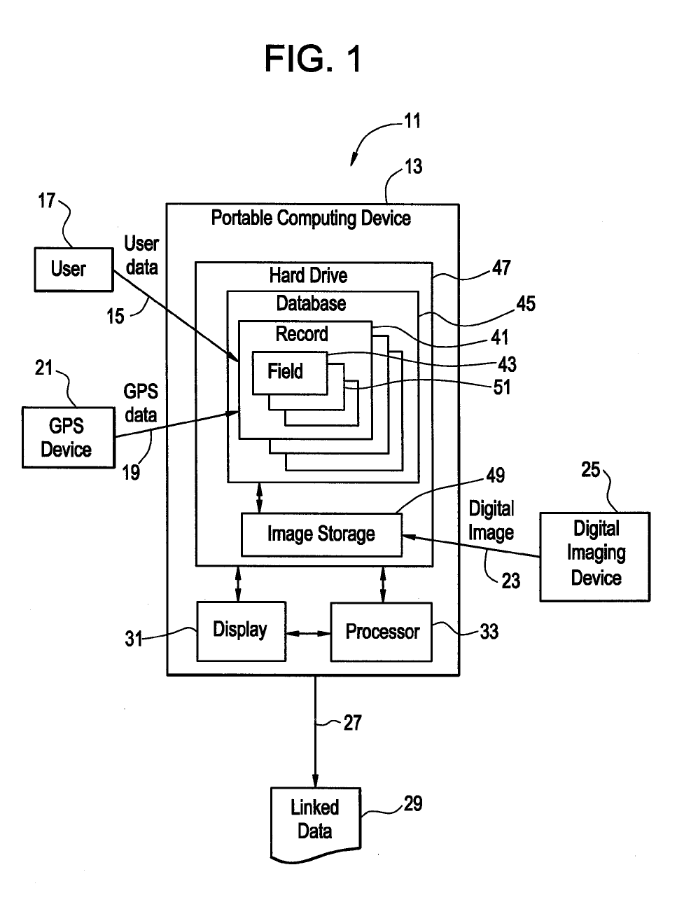

FIG. 1 illustrates a schematic layout of an exemplary system 11. A portable computing device 13 may receive user input and data 15 from a user 17. The portable computing device 13 may include a display 31 and a processor 33, in addition to other components. The processor 33 may execute the software of the present invention. The portable computing device 13 may receive GPS data 19 from a GPS device 21. The portable computing device 13 may receive a digital image 23 from a digital imaging device 25. The portable computing device 13 may send data 27 to a linked data storage 29, which may be separate or integrated with the portable computing device 13.

For purposes of this disclosure, a record 41 may be a group of fields 43 associated with one another. Many records 41 may combine to form a database 45. The database 45 may include a collection of records 41. Each record 41 may contain several fields 43. Fields 43 may include geographic data and user defined data. When the GPS device 21 transmits GPS data 19 and the user 17 enters user data 15, the GPS data 19 and/or the user data 15 may go directly into a record 41 in the database 45, which may be located on a hard drive 47 of the portable computing device 13. However, when a digital imaging device 25 records a digital image 23, the digital image 23 may not originally be stored as part of the record 41. The digital image 23 may instead be stored somewhere else on the hard drive 47, such as an image storage device 49 or an alternative directory. The software of the present invention may first detect the new digital image 23 in the image storage 49 of the hard drive 47, move the digital image 23 to the same directory as the database 45, and copy the file name of the digital image 23 into a field 43 on the record 41. After this is complete, the software may alter the digital image 23 by adding watermarks and/or metadata to the image file 23. The altered image may be stored as a separate image and linked by copying the name of the new image to an alternative field 51 in the record 41. All of this may be done automatically.

Initially, a user may create a database by describing desired fields and relationships between the desired fields. For the present application, the user may preferably include a desired field for the digital image and any altered digital images that may be created. Table 1 is an example of a database with field names across a top column. Upon creation the database may saved to a user defined directory on the portable computing device.

TABLE 1

| | | | | | | |
|---|---|---|---|---|---|---|
| | | | | | Altered | User |
| Latitude | Longitude | Date | Time | Image | image | Defined . . . |

| | | | | | | | |
|---|---|---|---|---|---|---|---|
| Sample | 39.9587 | −104.7382 | May 14, 2007 | 9:45:55 | xx.jpg, | xxx_tag.jpg | xxx |
| Record 1 | | | | | xy.jpg, | | |
| | | | | | xz.jpg | | |
| Description | | | | | Original | Watermarked | May be many |
| | | | | | photo | and/or | of them such |
| | | | | | | metadata | as condition, |
| | | | | | | added | color, serial |
| | | | | | | | number, etc. |

Once the database is created, the database may be ready to receive data. A new record may be created when new data is available. In some situations, a new record may be created by the software when a digital image is transferred to the portable computing device. In other situations, the user may create a record and this existing record may be modified by adding a link to the digital image. In either case, the user may add data to one or more desired fields. The methods and systems of the present invention may create links between data and other desired fields.

A method of the present invention may operate on a portable computing device and may monitor the download of digital images to the portable computing device. The method may alternatively monitor the taking of digital images if the digital imaging device is incorporated into the portable computing device.

Transfer of a digital image taken by the digital imaging device from the digital imaging device to the portable computing device may happen with a built-in mechanism on the portable computing device that allow transfers of data to and from the portable computing device, for example, Bluetooth, WiFi-type and other similar types of devices. The methods and systems of the present invention may monitor a directory where digital images are stored on the portable computing device. Upon recognizing new additions of digital images to the directory, the digital images may be linked to data as described in more detail below.

In currently available systems, the built-in portable computing device transfer process may require a user to perform several manual steps to accept a transfer of digital images. The systems and methods of the present invention may act as a mediator to the portable computing device's requests for input, thus allowing the user to transfer information automatically, without having to respond to queries from the portable digital computer.

Some current portable computing devices do not have software that allows for an integrated method of transferring information in or out of the portable computing device. The systems and methods of the present invention may facilitate transfer of digital images and location information to and from these portable computing devices.

Once a photo is transferred from a digital imaging device to a portable computing device, the software of the present invention may automatically insert a link to the digital image in the data record being collected on the portable computing device, which may optionally be connected to a GPS device.

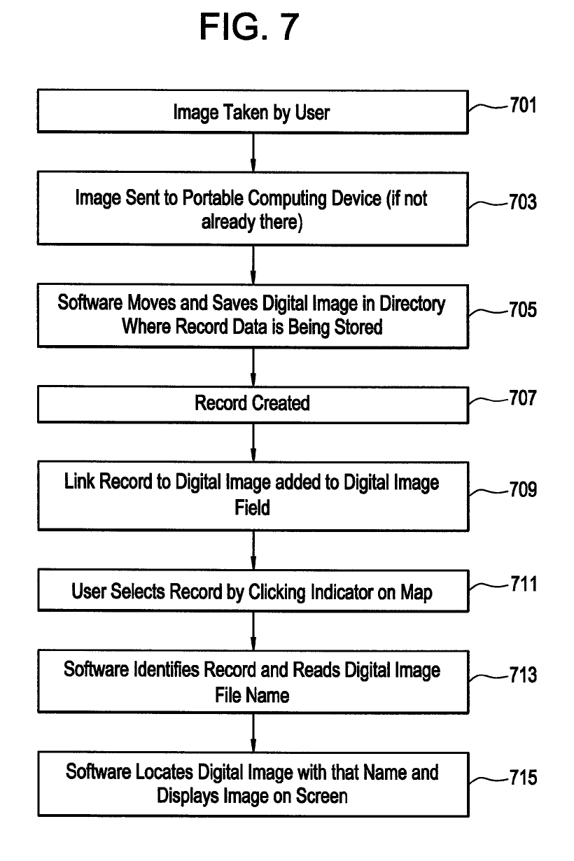

FIG. 7 shows an overview of the lining process. A user may take a digital image 701. The digital image may be sent to a portable computing device if not already on the portable computing device 703. To automatically link the present invention may first move the digital image into the same database directory where the data records are stored and then save the digital image in the database directory 705. That may be done in preparation for linking. When the application of the present invention is run, the software may begin to monitor the database directory for digital image files. Upon the arrival of a new digital image file, the software may copy the file name of the new digital image file to the appropriate field in the appropriate record in the database. The software may identify the appropriate field and record using information from a set-up procedure.

As an example, during the set-up procedure, a user may determine that each new image should initiate creation of a new record. Thus, the subsequent arrival of a new digital image in the directory may generate the creation of a new record. The first item added by the software in the new record may be the name of the new digital image. The user may then enter other data into the new record to accompany the new digital image file name. However, if the user set up the software differently, the file name may be copied into the predetermined field of a record that is already open.

After the digital image is moved to the database directory, a record may be created 707. Each record may contain several fields. A field may be added to a record that “links” to a digital image. The field that is added may be the file name of the digital image that has been transferred to the same directory as the data in the record. By inserting the file name, the digital image with that name becomes associated with the other information in that record, including GPS information and other information, because they are now part of the same record. The record is linked to the digital image added to the digital image field 709.

The new field, the file name of digital image in this example, may serve a special purpose in the software of the present invention. Upon request, the software may read the information as a file name and may search the database for files with that name. When the software finds the file, the information may be displayed.

Linked files may be accessed through the software of the present invention. Linked filed may be accessed, for example, on a portable computing device by having the user select a “view digital image icon”, such as the third button down 515 of FIG. 5. The user may then click on one of the points 513 on the map 711. This may select a record. The software may identify the record and may read the digital image file name from that record 713. The software may then look in the directory for the image file and display the digital image on a screen another type of display 715, not merely the digital image file name in a pop-up window or other type of display.

The links may occur not only within the portable computing device, but the links may remain associated with the database wherever the database resides. Because the information may be stored as part of the database, any user accessing or using the database may have built in access to the digital images, whether on the portable computing device or after the database is downloaded to another computer or system.

Digital images (both original digital images and digital images altered by watermarks or metadata) that are incorporated into records may be viewed within any database where the data resides. Users in the field may take digital images, link them to records with other data, create altered watermarked/metadata images and upload that data from the portable computing device onto a shared network for sharing. As long as the digital images are sent with the portable computing device record data, then the links may be maintained.

The software may also enable links to GPS points collected by the GPS device, so a user may click on points in a map and see the corresponding digital image. The software may be set to automatically create a data record when a digital image arrives at the portable computing device. The user may then be allowed to enter additional information. Alternatively, the user may then be allowed to select an already existing record, and attach the new digital images to that existing record.

In many cases, a user may take multiple digital images of one item, where the multiple digital images may need to be associated with the same data record and location information. The software of the present invention may allow the user to associate multiple digital images with each data record. As digital images are associated with a record they may be added as comma delimited file names within an image field of the record. An example is shown in Table 1 where three different digital images are separated by commas in the image record. Each digital image and/or image field may also have one or more altered digital images associated with the image field.

The software may also automatically watermark or label each digital image with critical information as defined by the user. This information may appear on the digital image when the digital image is viewed or printed. That information may include, but is not limited to, geographic data, date and time stamps, and other critical pieces related to a specific application of the user. In addition to labeling digital images with data, the software of the present invention may add information to the original digital image by incorporating data in the metadata of the digital image file. In this way critical information may be permanently embedded in the digital image file.

Users may choose to alter digital images by adding watermarks and/or metadata. When watermarks are added to images the underlying metadata may not be changed. Instead, the visual representation of the digital image is altered to include additional information written on top of the digital image or underneath the digital image in a text box that may become part of the digital image. When metadata are added, they may not alter the visual appearance of the image. The changes may be, however, accessible to many different kinds of software capable of reading the digital image files, including, but not limited to, graphic software, database, etc. When viewed by these software, the data may look like a spreadsheet with each field laid out as a column. Metadata may include information like: geographic position, date/time, camera make/model, camera parameters, user data, user entered data, etc. Most often digital images may be altered by adding both watermarks and metadata; however, it may be important to note that they are different things. Some users may add only metadata or only watermarks.

A similar process applies to either modification. Digital images may be altered by the following process:

1. During set-up, the user may select what information will be included in the watermarked digital image or metadata. The user may further select a place to store the digital image in each record. This field may be the same as or different from the original digital image being recorded. The following description assumes that the watermarked photo is stored as a separate file in addition to the original photo.

2. The user may record the digital image and the digital image may be linked with the record as described previously, i.e. the image may be saved to a directory and the file name from the original photo may be added to record.

Alterations may occur after the digital images are linked. This step may happen automatically. The following are preferred steps of alteration:

1. Software may identify a field specified during set-up to hold the new, altered digital image (assuming the user does not want to simply replace original digital image).

2. Software may read the information selected for inclusion in the alteration, as defined during the set-up.

3. Software may extract the information from the same record as the digital image, i.e. the record where the link is stored.

4. Software may alter the digital image by printing the extracted information onto a visual aspect of the digital image by creating a watermark or by adding information to the metadata of the digital image file.

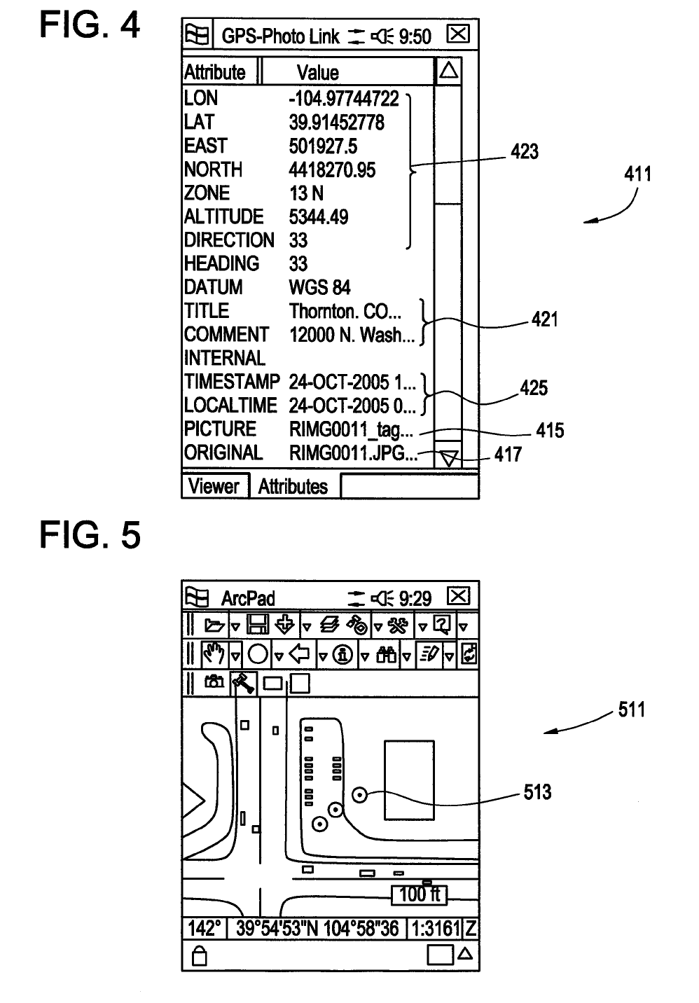

5. The new image may be saved under a different file name in the new field. This may preserve the original photo in its original state. For example, in FIG. 4, the field name “picture” 415 may be the altered watermarked/metadata added photo. The field name “original” may be the unaltered photo 417.

The incorporating software of the present invention may act as a mediator between a digital imaging device and geographic information software running on the portable computing device. The geographic information software may generally be a software program for mobile geographic information systems and field mapping applications using handheld and mobile devices that provides field-based users with the ability to capture, analyze, and display geographic information.

When the incorporating software detects a digital image arriving on the portable computing device, the incorporating software may automatically insert information about the digital image into the geographic information software. The insertion may occur via an extension running in the geographic information software, which links the geographic information software with the incorporating software. Without this extension, the geographic information software would not know when a digital image has arrived on the portable computing device. The incorporating software may modify a current record open in the geographic information software, and may append a digital image filename to the current record. If more than one digital image is taken for a particular current record, the incorporating software may append each digital image to the current record.

In a preferred embodiment of the present invention, the steps performed by the software, when executed by one or more processors, may include:

1. User creates a database on a portable computing devise by defining what fields they want to be part of each record. Those fields may include geographic data, user information, image data and image data altered to integrate geographic and other user data.

2. A user may choose, by clicking on a menu item or another similar process, to update a current record or to create a new record in the database when a digital image arrives on the portable computing device. This may begin the incorporating software's monitoring of the incoming digital image directory. Monitoring may be accomplished by periodically checking the directory on the portable computing device for new digital images.

3. A new digital image may be sent to the portable computing device via Bluetooth, WiFi, wireless, cable, internal imaging device or another similar method.

4. The new digital image may be automatically stored in a predetermined directory on the portable computing device by image transfer software used by the portable computing device.

5. The incorporating software may detect the new digital image in the predetermined directory and move the new digital image to the same directory where the user created database is stored.

6. The incorporating software may then copy the name of the copied image file into the designated field of the record that is being edited.

7. If a new record is to be created (via Step 2 above), the new record may be created upon the arrival of a digital image into the database directory. The incorporating software may begin by copying the file name of the image into the appropriate field and then add data from other devices, including GPS devices. Users may also edit the record once the record is created.

8. The incorporating software may process the new digital image by creating a watermarked digital image file or by otherwise annotating or associating the data into the new digital image. The processing steps may include:
a. Using the selection from Step 2, either updating a current record or creating a new record, the incorporating software may read information from the record and writes the information as text onto the digital image, thus creating a watermark or other annotation.
b. The incorporating software may also write the same information from the record to the header or metadata of the digital image file.
c. The incorporating software may save this altered document under a new name.
d. Copying the new name into a new field on the current record on the portable computing device.
e. If multiple digital images are taken, then all related digital images may be added to the current record. All related digital images may be comma delineated entries.

9. The user may then select a “View Digital Image” icon or menu item on the portable computing device. The user may be directed to a map or menu. The user may click on a point record indicated on the map to view all digital images associated with that point record.

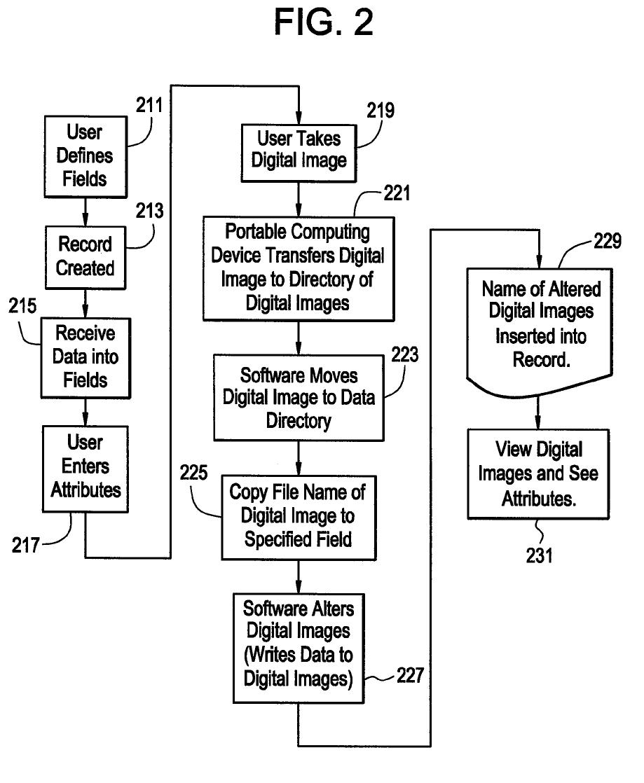

FIG. 2 illustrates exemplary steps if a user chooses to update a current record. Prior to taking any digital images, a user may select a database and define appropriate fields as described above 211. A record for the GPS position may be created 213 from the information entered by the user. Data may be received from an information source, such as a GPS device. The GPS data may come from a GPS device incorporated into the portable computing device or a GPS device separate from the portable computing device and transferred to the portable computing device. The GPS data may be transferred to the database as a field in a record 215. The user may enter any applicable attributes 217 for the record. The user may then take a digital image 219 with a digital imaging device associated with the portable computing device or with a digital imaging device separate from the portable computing device that then transfers the digital image to the portable computing device. The portable computing device may transfer the digital image to a directory of digital images 221 on the portable computing device. The incorporating software may then move the digital image to a data directory 223. The incorporating software may then copy the file name of the transferred image to a specified field in the open record 225. The incorporating software may then process the digital images 227 by writing data to the digital images and saving them as separate files in the database directory. The names of the altered digital images may be inserted into the record 229 in specified fields, which may be different from the original record. The user may then view the original or altered digital images and may see the attributes from the record 231. The original or altered digital images may be viewed on a map, via text or by another display method.

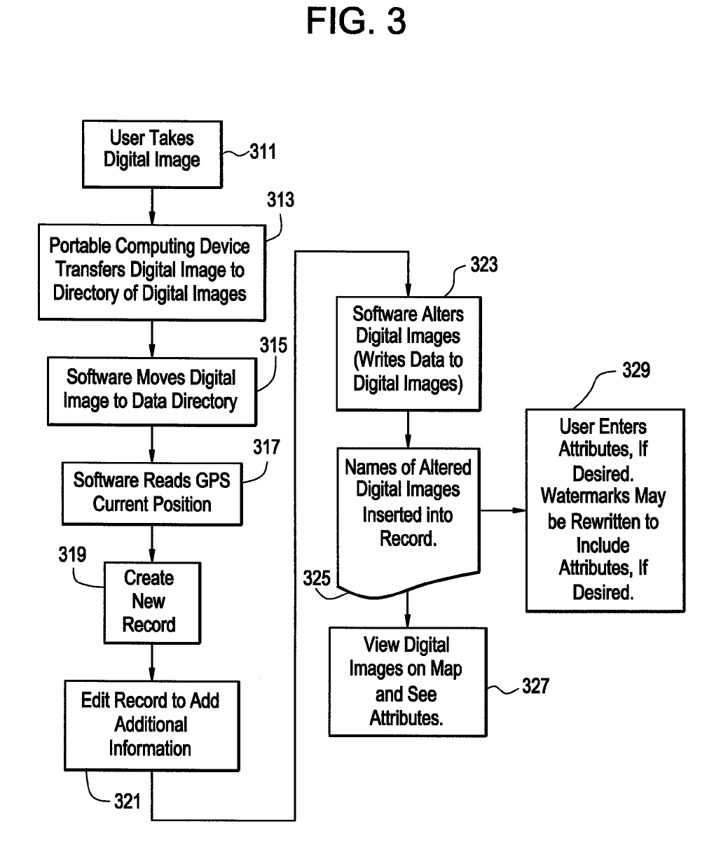

FIG. 3 illustrates exemplary steps if a user chooses to create a new record upon arrival of a digital image. A user may take a digital image 311 with a digital imaging device associated with the portable computing device or with a digital imaging device separate from the portable computing device that then transfers the digital image to the portable computing device. The portable computing device may transfer the digital image to a directory of digital images 313 on the portable computing device. The incorporating software may then move the digital image to a data directory 315. The incorporating software may create a new record and may populate the appropriate field with the name of the digital image it just moved 317. The incorporating software may then read a current position or other data from a GPS device or other data source 317. Users may edit the record to add additional information 321. The incorporating software may then process the digital images 323 by writing data to the digital images as watermarks or other annotations and saving them as separate files in the database directory. The names of the altered digital images may be inserted into the record 325 in specified fields, which may be different from the original record.

The user may view the digital images and may see the attributes from the record 327. The original or altered digital images may be viewed on a map, via text or by another display method. The incorporating software may look to the selected record, find the name of the digital image listed in the field, identify the record with that name and displays that digital image.

The user may enter attributes 329, if desired.

FIG. 4 illustrates an exemplary record 411. The incorporating software may insert attributes 413 into the digital image file. Multiple digital images may be viewed by scrolling or otherwise selecting various digital images. Both an altered digital image 415 (digital image with a name tag) and an unaltered digital image 417 may be seen. The coordinate 423 and timestamp data 425, for example, may come from a GPS device. The title and comment data 421, for example, may be manually entered by the user. The digital image data, for example, may come via the incorporation software.

When the user selects a viewer 419, as shown in FIG. 4, a map view 511 may become available, as shown in FIG. 5. Location indicators 513 may indicate where digital images associated with records were taken. A toolbar 515, the third menu down on the left at the top of the map view 511, may be a toolbar associated with the incorporating software. The toolbar 515 may allow for various manipulations and viewing of the digital images and maps.

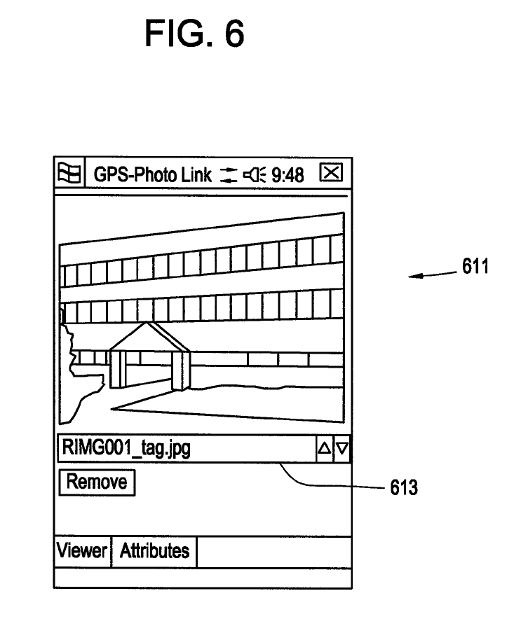

When a user clicks on a location indicator 513, the incorporating software looks to the selected record 513, finds the name of the image listed in the field 417 or 415, identifies the record with that name and displays that image 611, as shown in FIG. 6. Name or other information 613 may be selectable.

A machine-readable medium may include encoded information, which when read and executed by a machine causes, for example, the methods and systems of the present invention to be executed. The machine-readable medium may store programmable parameters and may also store information including executable instructions, non-programmable parameters, and/or other data. The machine-readable medium may comprise read-only memory (ROM), random-access memory (RAM), nonvolatile memory, an optical disk, a magnetic tape, and/or magnetic disk. The machine-readable medium may further include, for example, a carrier wave modulated, or otherwise manipulated, to convey instructions that can be read, demodulated/decoded and executed by the machine (e.g., a computer). The machine may comprise one or more microprocessors, microcontrollers, and/or other arrays of logic elements.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A method of associating information with a digital image comprising:
creating a record on a database, wherein the record comprises one or more user-defined fields,
monitoring a digital image storage on a portable computing device for new digital images,
detecting one or more new digital images, corresponding to the record, in the digital image directory, wherein the one or more new digital images are each associated with a unique image name,
transferring the one or more new digital images to the database,
copying the unique image names to a user-defined field within the record,
altering the one or more new digital images automatically to create one or more altered digital images and corresponding altered image names, and
inserting the one or more altered image names into a different user-defined field within the record.

2. The method of claim 1, wherein the monitoring comprises periodically checking the digital image directory for new digital images.

3. The method of claim 1, wherein the new digital images are sent to the digital image directory upon receipt of the new digital images by the portable computing device.

4. The method of claim 3, wherein the new digital images are received by the portable computing device via digital communications selected from the group consisting of Bluetooth, WiFi, wireless, cable, internal imaging systems, and combinations thereof.

5. The method of claim 1, wherein the new digital images are sent to the digital image directory upon receipt of the new digital images by image transfer software on the portable computing device.

6. The method of claim 1, wherein the altering further comprises associating the one or more new digital images with data from an outside data source.

7. The method of claim 1, wherein the outside data source is a global positioning device.

8. The method of claim 1, wherein the outside data source is user-entered data.

9. The method of claim 1, wherein the altering further comprises adding a watermark.

10. The method of claim 9, wherein the adding the watermark further comprises:
reading the information from the new record,
writing the information from the new record as text onto the one or more new digital images,
saving the altered digital image under a new name, and
copying the new name into another field in the record.

11. The method of claim 1, wherein the altering further comprises adding metadata.

12. The method of claim 11, wherein the adding metadata further comprises:
reading the information from the new record,
writing the information from the new record into the header or metadata of the one or more new digital images,
saving the altered digital image under a new name, and
copying the new name into another field in the record.

13. The method of claim 1, further comprising associating two or more new digital images with a single record.

14. The method of claim 1, further comprising displaying the one or more altered digital images.

15. The method of claim 14, wherein the displaying is on a map with indications of the source location of the one or more altered digital images.

16. A method of associating information with a digital image comprising:
monitoring a digital image storage on a portable computing device for new digital images, wherein the one or more new digital images are each associated with a unique image name,
detecting one or more new digital images in the digital image storage,
transferring the one or more new digital images to a database,
requesting data from an outside data source,
receiving data from an outside data source in the database,
creating a record,
copying the unique image names to a user-defined field within the record,
altering the one or more new digital images automatically to create one or more corresponding altered digital images and corresponding altered image names, wherein the processing associates the one or more new digital images with information from the record, and
inserting the one or more altered image names into a different user-defined field within the record.

17. The method of claim 16, further comprising accepting user entered attributes into the record.

18. The method of claim 17, further comprising viewing the altered digital images and the attributes on a display.

19. A system for associating information with a digital image comprising:
a portable computing device for receiving one or more digital images from a digital imaging device,
wherein the portable computing device receives data corresponding to the one or more digital images from a data device,
wherein the portable computing device creates a new record based on the data,
wherein the portable computing device processes the one or more digital images to create one or more corresponding altered digital images, wherein the processing automatically associates the one or more digital images with the data from the new record, and
wherein the one or more annotated digital images are displayed on a display of the portable computing device.

20. The system of claim 19, wherein the portable computing device is selected from the group consisting of a laptop, portable digital assistant, cellular telephone, digital video, and combinations thereof.

21. The system of claim 19, wherein the digital imaging device is a digital camera separate from the portable computing device.

22. The system of claim 19, wherein the digital imaging device is a digital camera incorporated into the portable computing device.

23. The system of claim 19, wherein the data device is separate from the portable computing device.

24. The system of claim 19, wherein the data device is incorporated into the portable computing device.
